(19) United States
(12) Patent Application Publication
(10) Pub. No.: US 2007/0151148 A1
(43) Pub. Date: Jul. 5, 2007

(54) Modular garden environmental containment system and method

(76) Inventor: David Hoch, Belmont, MA (US)

Correspondence Address: Richman and Associates, PO Box 3333, La Jolla, CA, 92038-3333, US

(21) Appl. No.: 11/650,259

(22) Filed: Jan. 5, 2007

Related U.S. Application Data
(60) Provisional application No. 60/756,932, filed on Jan. 5, 2006.

(51) Int. Cl. A01G 13/02

(52) U.S. Cl. 47/32; 47/31.1

(57) ABSTRACT

Modular garden environmental apparatus and methods including apparatus to limit weed growth to nearby one or more plants, protecting the plants from insects and animals, providing additional thermal retention, automatically maintaining a desired soil moisture control near the plants, providing a method of fertilizer delivery and providing vertically offset regions for plants.

### CROSS-REFERENCE TO RELATED APPLICATIONS

This application is related to U.S. Provisional Application 60/756,932, Attorney Docket DH003US, filed Jan. 5, 2006, and entitled “Modular Garden Environmental Containment System and Method” and U.S. Provisional Application 60/756,589, Attorney Docket DH002US, filed Jan. 4, 2006, and entitled “Modular Garden Environmental Containment System and Method”, which are each incorporated by reference herein.

### BACKGROUND

1. Field of the Invention

The invention relates generally to gardening systems and methods, and more particularly, to garden environment maintenance or containment systems and methods.

2. Description of Related Art

It may be desirable to control weed growth, insect exposure, animal exposure, moisture level, fertilizer levels, and temperature near or about one or more plants in a soil bed. The present invention provides such a system and method.

### BRIEF DESCRIPTION OF THE DRAWINGS

The features, objects, and advantages of the present invention will become more apparent from the detailed description set forth below when taken in conjunction with the drawings in which like reference characters identify correspondingly throughout and wherein:

FIGS. 1A and 1B are simplified isometric diagrams of soil covers having adjustable plant windows in accordance with the present invention;

FIG. 2 is a simplified isometric diagram of pins that may be used with the soil cover having adjustable plant windows shown in FIGS. 1A and 1B in accordance with the present invention;

FIG. 3A is a simplified side view of a retracted plant window shown in FIGS. 1A and 1B in accordance with the present invention;

FIG. 3B is a simplified side view of a contracted plant window shown in FIGS. 1A and 1B in accordance with the present invention;

FIG. 3C is a simplified isometric view of a retracted plant window shown in FIGS. 1A and 1B in accordance with the present invention;

FIG. 3D is a simplified isometric view of a retracted plant window shown in FIGS. 1A and 1B in accordance with the present invention;

FIG. 3E is a simplified isometric view of a contracted plant window shown in FIGS. 1A and 1B in accordance with the present invention;

FIG. 4A is a simplified top diagram of a soil cover having adjustable plant windows with plant spacing graphics in accordance with the present invention;

FIG. 4B is a simplified top diagram of a soil cover architecture including two soil covers shown in FIG. 4A in a configuration in accordance with the present invention;

FIG. 4C is a simplified top diagram of another soil cover architecture including two soil covers shown in FIG. 4A in a configuration in accordance with the present invention;

FIG. 4D is a simplified top diagram of another soil cover architecture including four soil covers shown in FIG. 4A in a configuration in accordance with the present invention;

FIGS. 4E to 4H are simplified top diagrams of soil cover architecture including a plurality of soil covers in accordance with the present invention;

FIGS. 4I to 4J are simplified top diagrams of soil cover architecture including a plurality of soil covers and plantings in accordance with the present invention;

FIG. 5 is a simplified isometric diagram of an insect exclusion system that may be removably attached to the soil cover shown in FIGS. 1A and 1B in accordance with the present invention;

FIG. 6A is a simplified side view of a side pole or post that may be employed in the system shown in FIG. 5 in accordance with the present invention;

FIG. 6B is a simplified side view of a center pole or post that may be employed in the system shown in FIG. 5 in accordance with the present invention;

FIG. 7A is a simplified isometric diagram of an automated hydration system that may be removably attached to the soil cover shown in FIGS. 1A and 1B in accordance with the present invention;

FIG. 7B is a simplified isometric diagram of a hydration control station that may be employed in the automated hydration system shown in FIG. 7A in accordance with the present invention;

FIG. 7C is a simplified isometric diagram of a soil hydration monitor that may be employed in the automated hydration system shown in FIG. 7A in accordance with the present invention;

FIG. 8A is a simplified isometric diagram of a flightless animal exclusion system that may be removably attached to the soil cover shown in FIGS. 1A and 1B in accordance with the present invention;

FIG. 8B is a simplified side view of a side pole or post that may be employed in the system shown in FIG. 8A in accordance with the present invention;

FIG. 8C is a simplified isometric diagram of a flightless animal exclusion architecture including a single exclusion system removably attached to the soil cover shown in FIGS. 1A and 1B in accordance with the present invention;

FIG. 8D is a simplified isometric diagram of another flightless animal exclusion architecture including multiple exclusion systems removably attached to the soil cover shown in FIGS. 1A and 1B in accordance with the present invention;

FIG. 9 is a simplified isometric diagram of a vertical extension system that may be removably attached to the soil cover shown in FIGS. 1A and 1B in accordance with the present invention;

FIG. 10 is a simplified isometric diagram of a thermal retention system that may be removably attached to the soil cover shown in FIGS. 1A and 1B in accordance with present invention;

FIG. 11A is a simplified isometric diagram of a section of the soil cover shown FIGS. 1A and 1B indicating fertilizer placement areas in accordance with an embodiment of the present invention; and

FIG. 11B is a simplified side view of fertilizer rods that may be employed in the system shown in FIG. 5A in accordance with an embodiment of the present invention.

### DETAILED DESCRIPTION

Throughout this description, embodiments and variations are described for the purpose of illustrating uses and implementations of the invention. The illustrative description should be understood as presenting examples of the invention, rather than as limiting the scope of the invention.

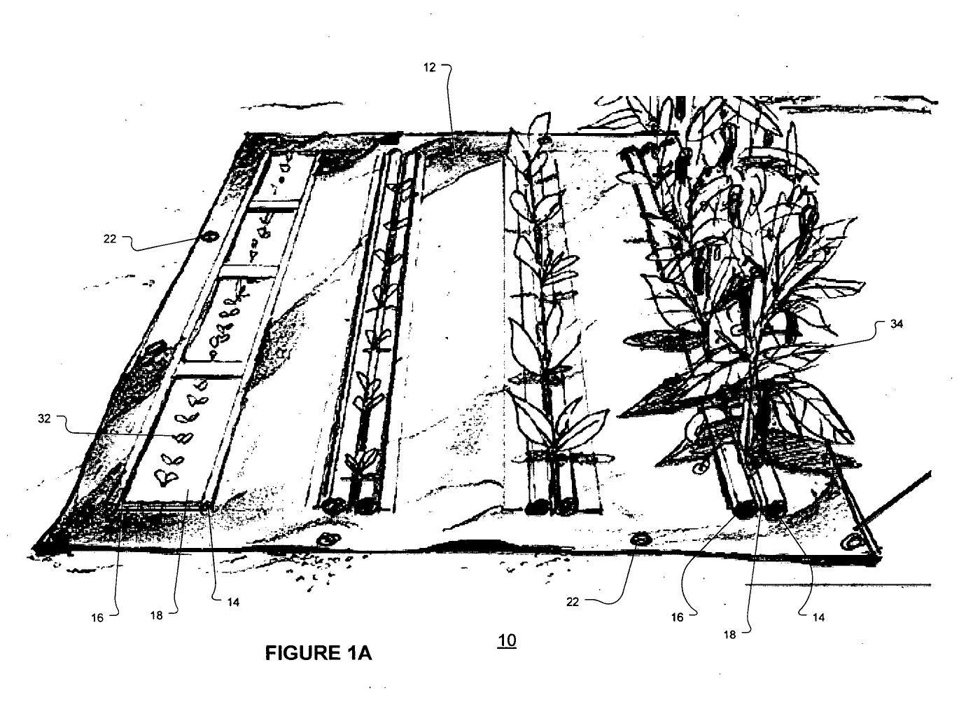

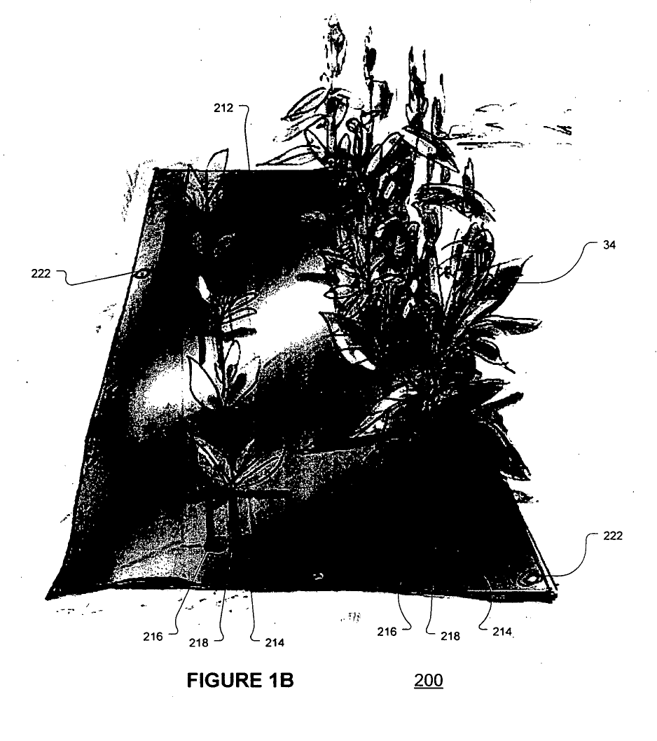

FIG. 1A is a simplified isometric diagram of a soil cover 10 having adjustable plant windows 18 in accordance with the present invention. In an embodiment the soil or landscape cover 10 includes four rows of windows 18 having four sub-windows in an embodiment. Each window 18 is bordered by a pair of moveable, weighted flaps 14, 16. In an embodiment each flap 14, 16 extends along the window length and may be rolled from an open position to create a large plant area 18 as shown on the left for seedlings 32. In an embodiment the flaps 14, 16 may be rolled to a substantially closed position to accommodate one or more desired plants 34. The flaps 14, 16 and cover material 12 are constructed of a heavy duty landscape fabric that ideally permits moisture to be absorbed and transported to soil below the fabric while preventing weed growth due to its weight and density. The fabric may include a polypropylene based, non-woven geotextile material. The fabric may also be a dark color to absorb more radiation including substantially black.

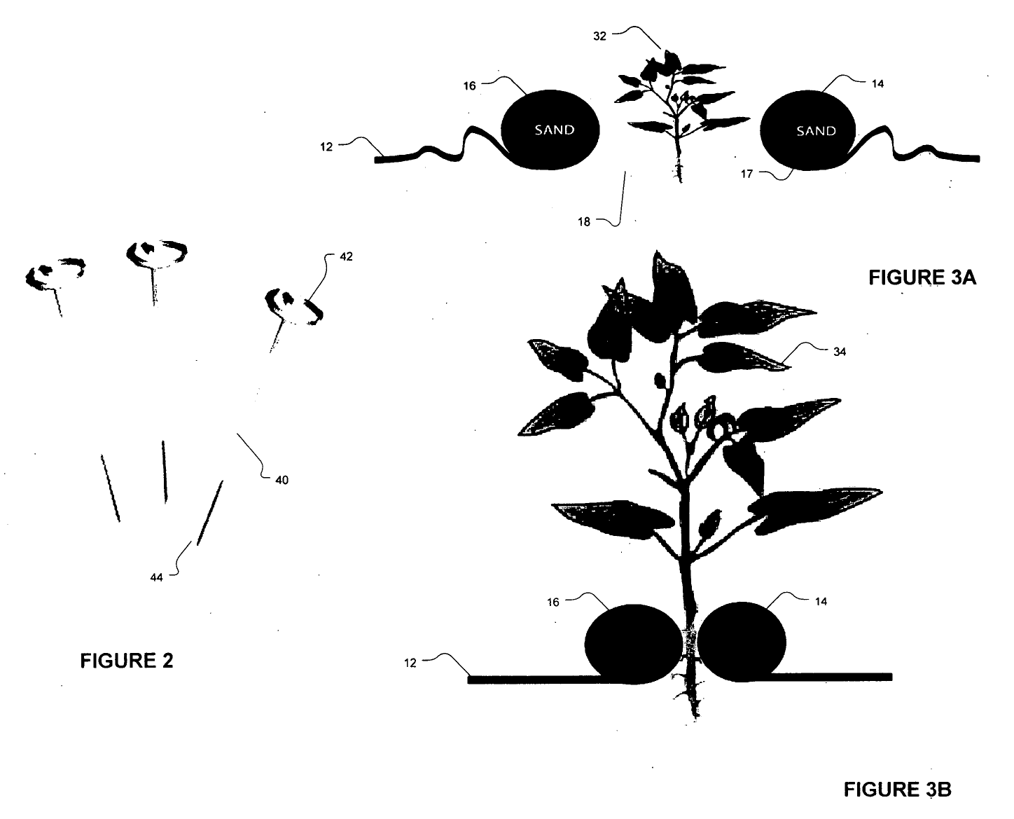

The soil cover 10 may also include metal encased grommets 22 along its border. In an embodiment the metal grommets are brass grommets 22. In an embodiment, the soil cover 10 is sized about six feet square and includes twelve (12) grommets (one at each corner and two off center on each side). In other embodiments the soil cover 10 size may be 6′×12′, 12′×12′, 12′×18′, or 3′×6′ as shown in FIG. 1B. The soil cover 200 shown in FIG. 1B also includes adjustable plant windows 218 in the fabric 212 framed by extendable, retractable flaps 214, 216. The soil cover 200 may have a length that is a multiple of its width (3′ width and 6′ length in an embodiment) so the soil cover 200 may be folded for different soil architecture. The soil cover 200 may also include metal encased grommets 222 along its border. FIG. 2 is a simplified isometric diagram of pins or stakes 40 that may be inserted into soil via the soil cover 10 grommets 22 in accordance with the present invention. The stakes 40 may include a pointed distal end 44 and enlarged proximal end 42. In an embodiment the stakes 40 may be fabricated from plastic, fiberglass, metal, or other resilient material including aluminum.

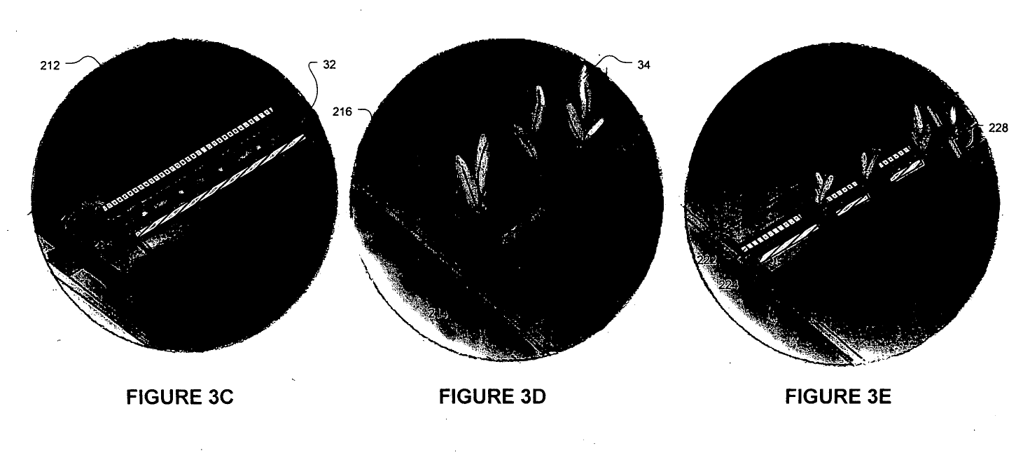

FIG. 3A is a simplified side view of soil cover 10, 200 with retracted window 18 flaps 14, 16, forming a large plant window 18 in accordance with the present invention. FIG. 3B is a simplified side view of soil cover 10, 200 window 18 flaps 14, 16 extended, forming a substantially closed, small plant window 18 in accordance with the present invention. In an embodiment, a soil cover 10, 200 user may fold back or retract flaps 14, 16 to create a large soil window 18 so that soil within the window 18 may be cultivated. After the soil is cultivated, seeds may be planted and the window 18 flaps 14, 16 may be retracted until the seeds germinate (FIG. 3C) and the plants 32 are a few inches tall (FIG. 3D). Then a soil cover 10, 200 user may extend the window 18 flaps 14, 16 to reduce soil exposure (FIG. 3E). The reduced soil exposure (small window 18) may reduce undesirable plant growth (weeds) and help maintain soil moisture and temperature for plantings 34.

In an embodiment, a soil cover 10, 200 user may transplant mature seedlings 32 or plantings 34. In such an embodiment, the user may retract the window 18 flaps 14, 16 to plant the seedlings (FIG. 3D) and then extend the flaps to reduce soil exposure (FIG. 3E). In an embodiment, the flaps may include an enlarged end 17 that may be filled with sand, water, or other pliable material. In an embodiment the enlarged window 18 flap 14, 16 end 17 may have about a 1.5 inch diameter. The enlarged window 18 flap 14, 16 ends 17 may help keep the soil cover 10 grounded in addition to the pins or stakes 22. In an embodiment, the enlarged flap 14, 16 ends 17 may be filled with a combination of sand and water-holding granules. The window 18 flap 14, 16 ends 17 may help keep the adjacent soil moist. The window 18 flap 14, 16 ends 17 may also be formed of long, durable, sealable bags. The bags may be filled with a flowable material or liquid, such as water and then sealed. The bags may also be filled with a liquid having a lower freezing point than water to prevent expansion and damage to the ends 17.

As shown in FIG. 3C one or more locking mechanisms 222, 224 may be coupled to a window 18 flap 14, 16 (214, 216) end. The locking mechanisms 222, 224 may securely match a first flap 14, 214 to a second flap 16, 216 to securely reduce the corresponding soil cover 10, 200 window 18, 218. The locking mechanisms 222, 224 any releasably, securable mechanism including Velcro® type products, zippers, or buttons. As shown in FIG. 3E the locking mechanisms 222, 224 may be segmented to enable plantings 34 to pass there-between. In an embodiment each flap 14, 214, 16, 216 end 17 may include indentations 228 (FIG. 3E) to facilitate folding of the soil cover 10, 200 at such indentations 228.

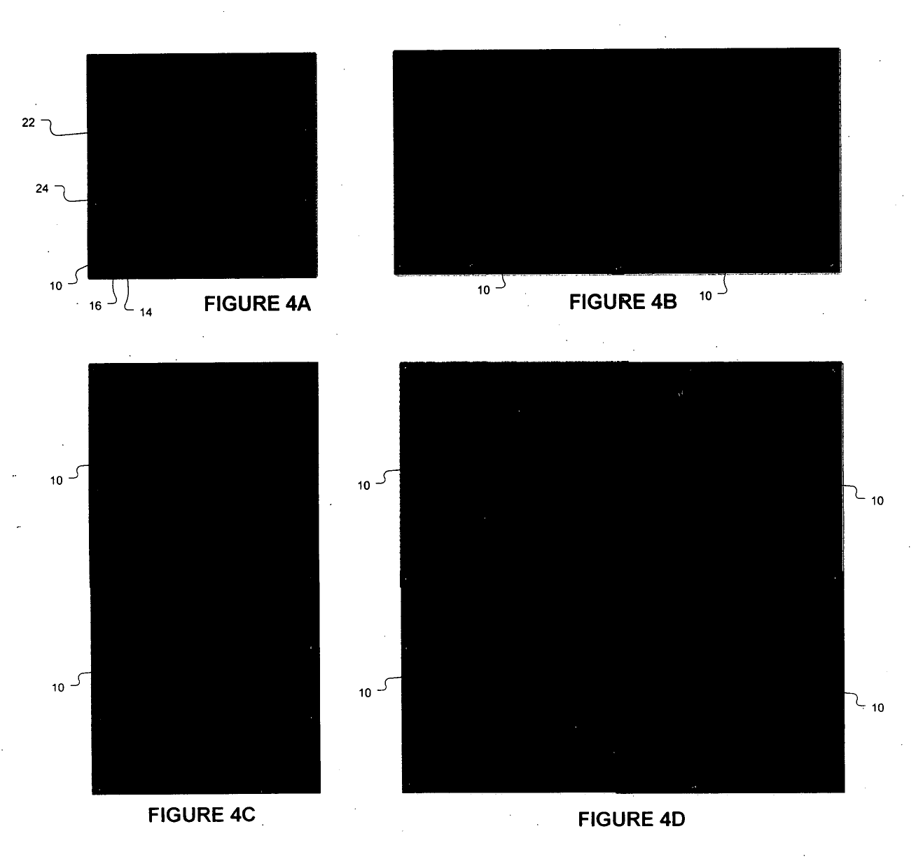

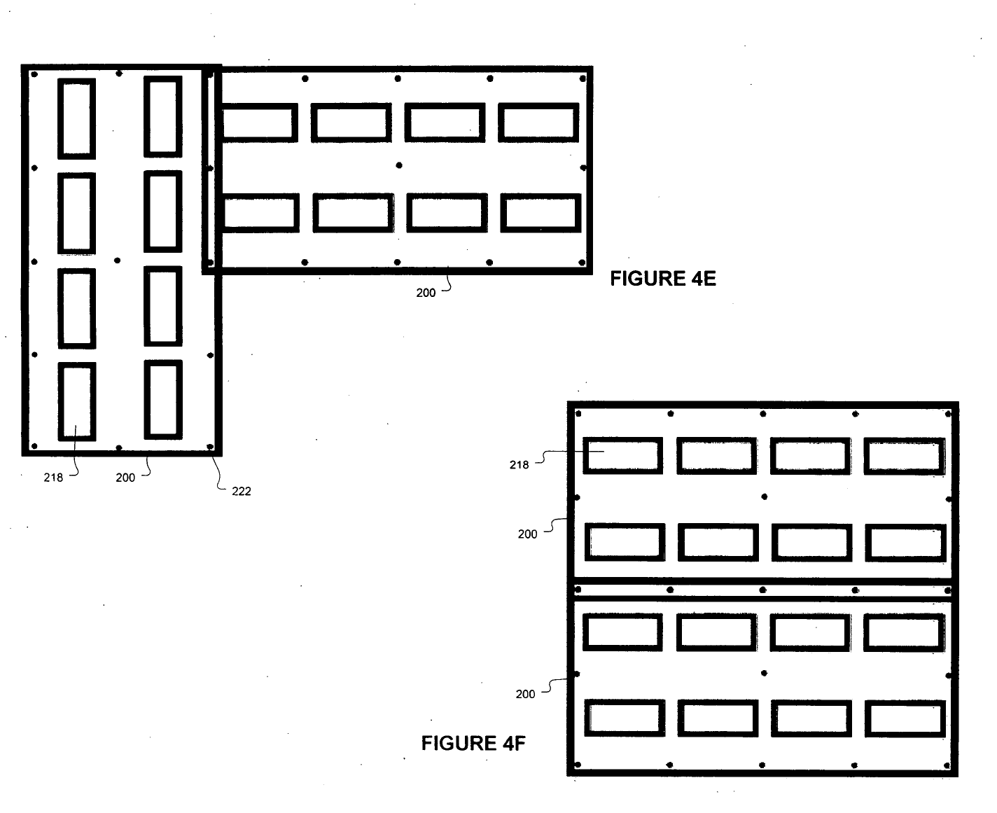

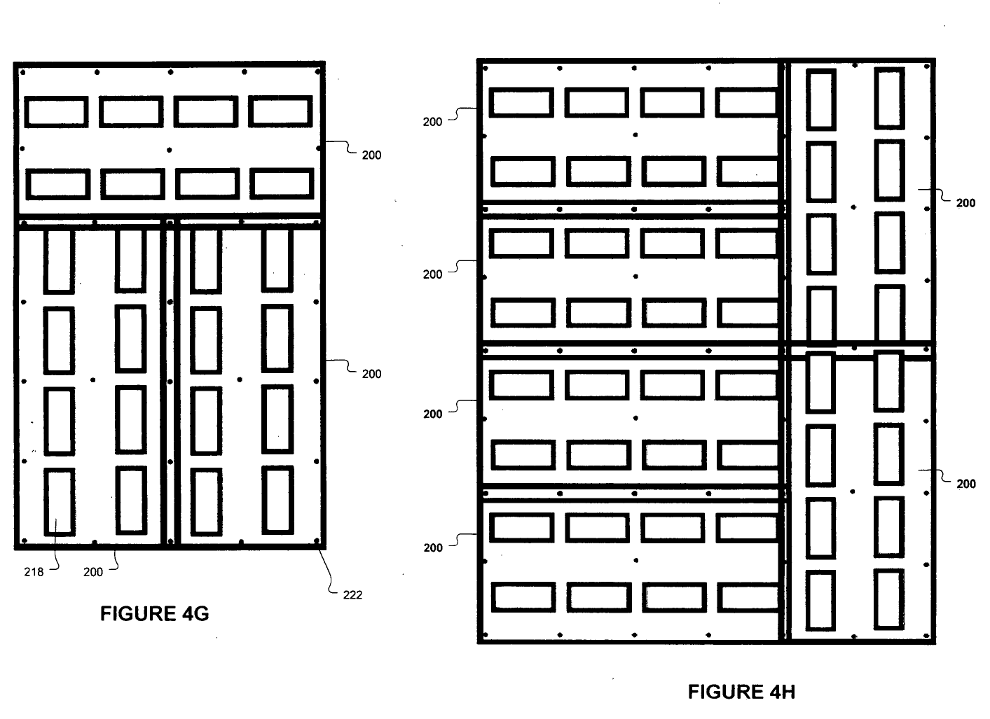

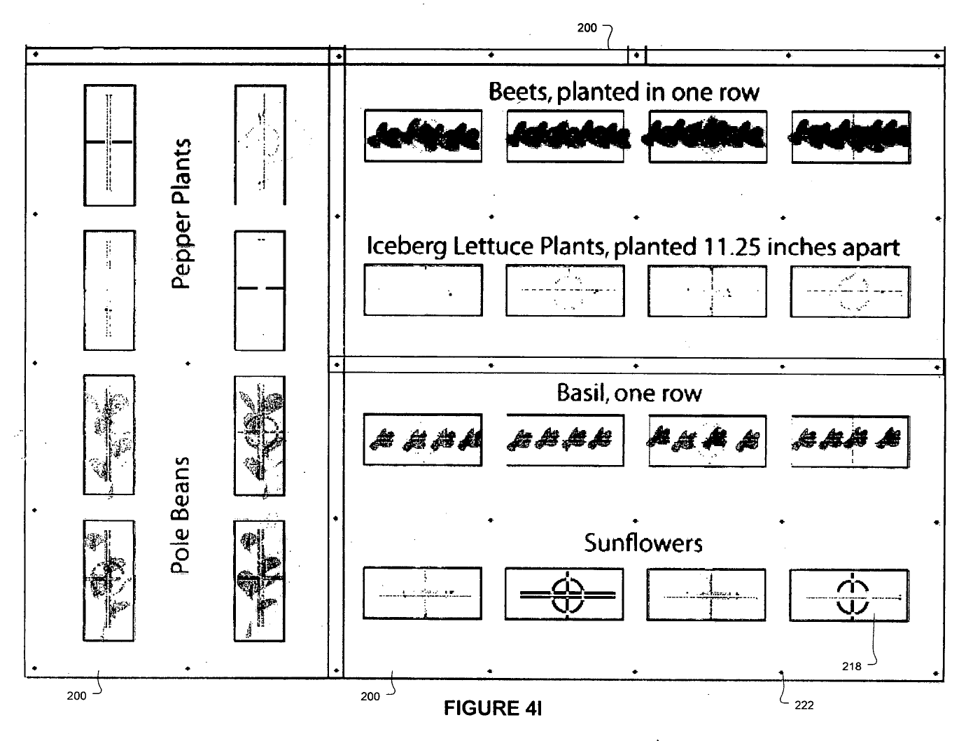

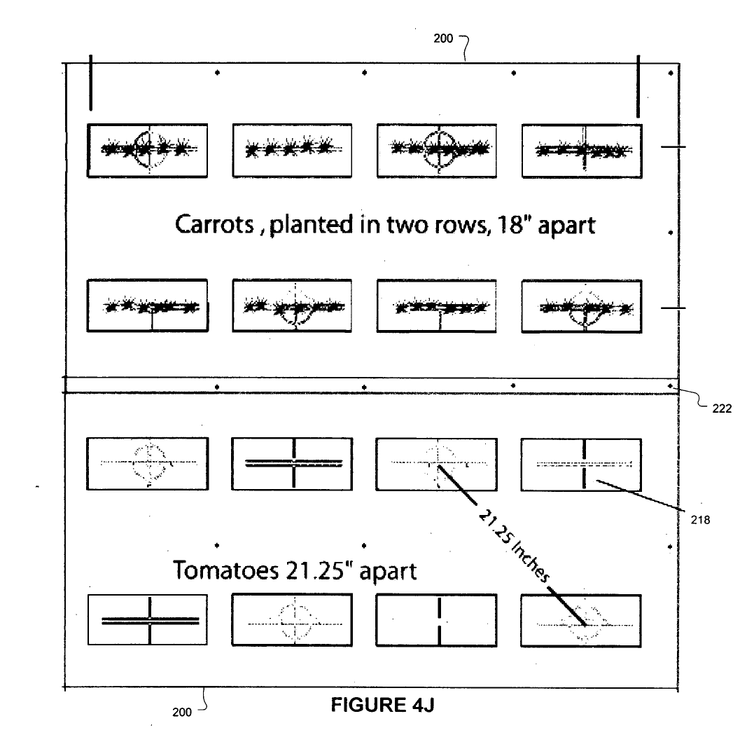

FIG. 4A is a simplified top diagram of a soil cover 10 having adjustable plant windows 18 with plant spacing graphics 24 in accordance with the present invention. In an embodiment where each soil cover 10 forms a six foot square, each window center may be about 17.25″ apart from an adjacent window 18 center. The graphics 24 may include nomenclature to indicate where plants should be located using different planting and spacing topologies. In an embodiment the grommets 22 may be mathematically placed on the fabric 12 so they may be attach (and overlap) with adjacent soil covers 10. FIG. 4B is a simplified top diagram of a soil cover architecture or topology including two soil covers 10 in a configuration in accordance with the present invention. FIG. 4C is a simplified top diagram of another soil cover architecture including two soil covers in a configuration in accordance with the present invention. FIG. 4D is a simplified top diagram of another soil cover architecture including four soil covers shown in FIG. 4A in a configuration in accordance with the present invention.

FIGS. 4E to 4H are simplified top diagram of soil cover architecture comprised of soil covers where the width is an integer multiple of the length (2:1 in these figures). FIG. 4E is a diagram of a corner architecture including two soil covers 200. FIG. 4F is a diagram of a square architecture including two soil covers 200. FIG. 4G is a diagram of a rectangular architecture including three soil covers 200. FIG. 4H is a diagram of another rectangular architecture including six soil covers 200.

FIGS. 4I and 4J are simplified top diagram of soil cover architectures with representative plantings. The soil cover architecture shown in FIG. 4I includes three soil covers 200. In a first soil cover 200 beet and lettuce plantings are inserted into each window 218. In another soil cover 200 basil plantings are inserted into each window of a row and sunflower plantings are inserted into alternate windows of the second row. In a third soil cover 200 pole bean plantings are inserted into the first, two windows of the two rows and pepper plantings are inserted into diagonal windows of the first and second row. The soil cover architecture shown in FIG. 4J includes two soil covers 200. In a first, upper soil cover 200 carrot plantings are inserted into each window 218 where the rows are about 18 inches apart. In the lower soil cover 200 tomato plantings are inserted into alternative and offset windows of each row so that each tomato planting is about 21.25 inches apart in a 3′×6′ soil cover.

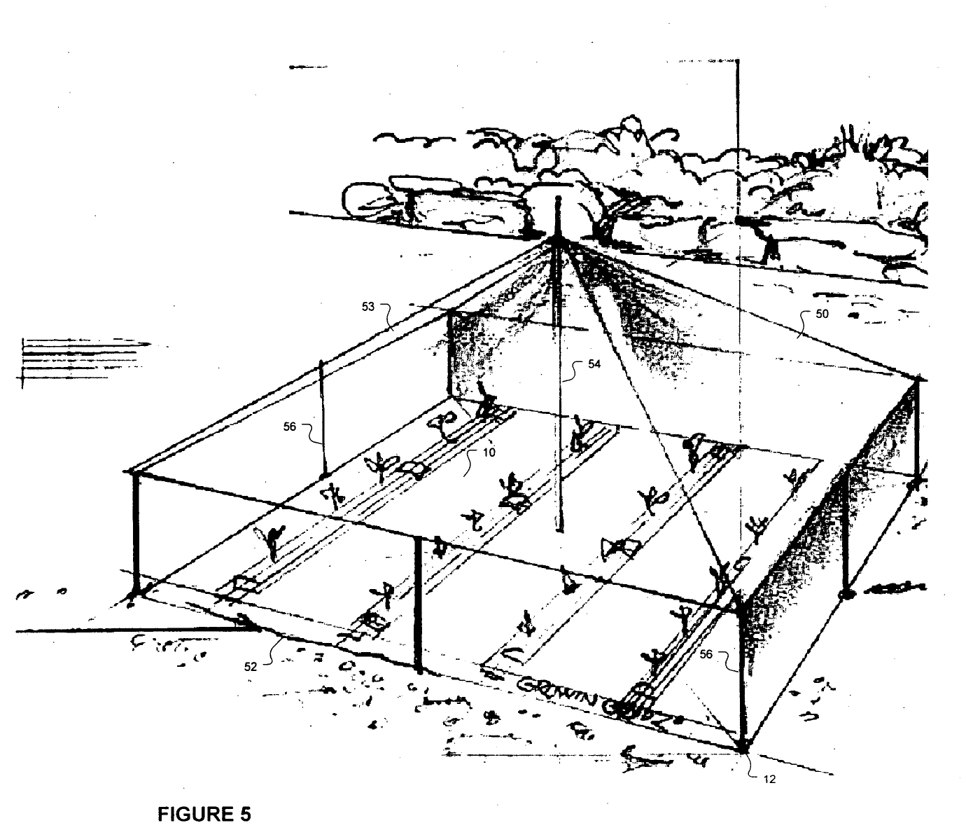

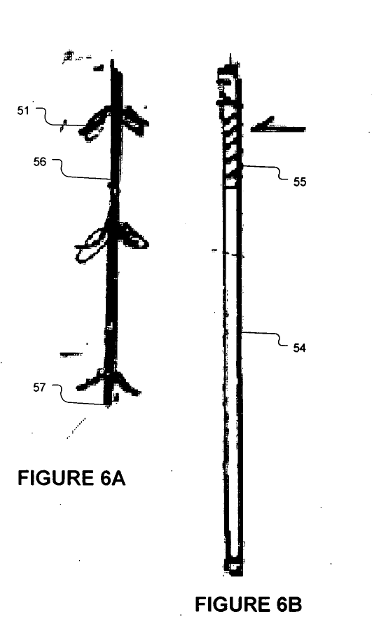

In an embodiment the soil cover 10, 200 may be folded over itself to form other configurations. At the end of a planting season or cycle, the pins or stakes 22 may be removed and the cover 10 may be cleaned and stored for the next planting season or cycle. FIG. 5 is a simplified isometric diagram of an insect exclusion system 50 that may be removably attached to the soil cover 10, 200 shown in FIGS. 1A and 1B in accordance with the present invention. In an embodiment the insect exclusion system 50 includes a net 53 couplable to the soil cover 10, 200 via a plurality of exterior poles 56 and center pole 54. FIG. 6A is a simplified side view of a side pole or post 56 that may be employed in the system 50 shown in FIG. 5 in accordance with the present invention. FIG. 6B is a simplified side view of a center pole 54 or post that may be employed in the system 50 shown in FIG. 5 in accordance with the present invention. The side posts or poles 56 include a distal end 57 and net hooks 51. In an embodiment the pole 56 distal end 57 may be inserted into a grommet 22 of the soil cover 10. The center pole 54 may include a spring section 55. In an embodiment the net 53 may formed of a mesh that permits the communication of air, light, and moisture. In an embodiment the net 53 may include weights 52 along its edges to hold the net against the soil cover 10.

In an embodiment the net 53 may be replaced with a transparent sheeting material 120 such as shown in FIG. 10 to form a thermal retention system that may be removably attached to the soil cover in accordance with the present invention. In an embodiment the sheeting material 120 includes an ultraviolet resistant plastic. The thermal retention system may help retain thermal energy within its enclosure and protect plants in the soil cover 10, 200 from insects and animals. In an embodiment the sheeting material 120 may be sized to protect or insulate multiple soil covers 10, 200.

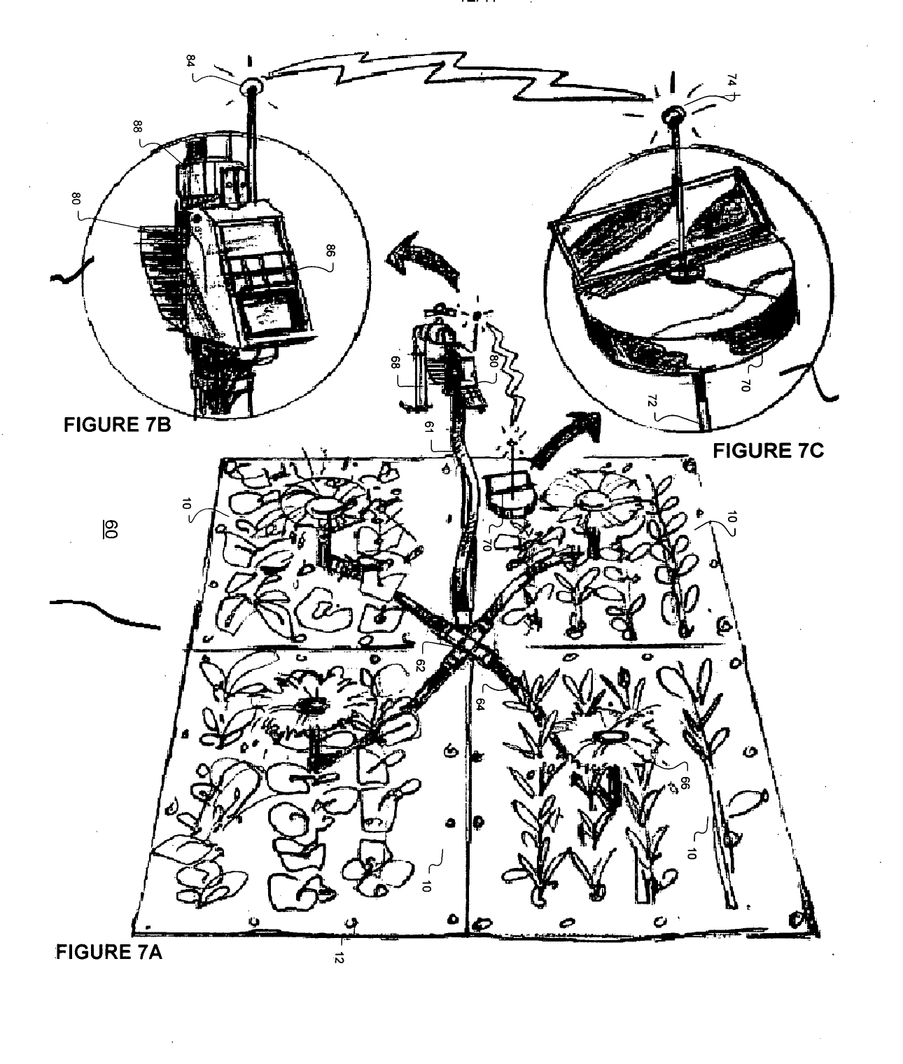

FIG. 7A is a simplified isometric diagram of an automated hydration system 60 that may be inserted through an opening in a soil cover 10, 200 to contact the soil in a particular location in accordance with the present invention. In an embodiment the hydration system 60 includes a control station 80 and a soil hydration monitor 70. The control system 80 may be coupled to a water supply 68 and field hub 62 via a hose 61. One or more sprinklers 66 may be coupled to the field hub 62 via hoses or pipes 64. Any configuration may be employed in conjunction with the soil cover(s) 10, 200. FIG. 7B is a simplified isometric diagram of a hydration control station 80 that may be employed in the automated hydration system 60 in accordance with the present invention. In an embodiment the hydration control system 80 includes a control panel 86, antenna 84, and water supply coupler 88. In an embodiment the control system 80 communicates wirelessly with a soil hydration monitor 70. A user may program the system 80 via the interface 86 to automatically regulate water distribution as a function of the desired soil moisture. In another embodiment, the system 80 may communicate with multiple hydration monitors 70 and control multiple fields based on the monitor 70 data.

FIG. 7C is a simplified isometric diagram of a soil hydration monitor 70 that may be employed in the automated hydration system 60 shown in FIG. 7A in accordance with the present invention. The monitor 70 includes a moisture sensor 72 and antenna 74. In an embodiment the sensor 72 may measure the ground resistance, impedance, capacitance, or inductance and use any combination of these measurements to determine the adjacent soil moisture. In an embodiment the soil hydration monitor 70 and control system 80 may be solar powered, in whole or part.

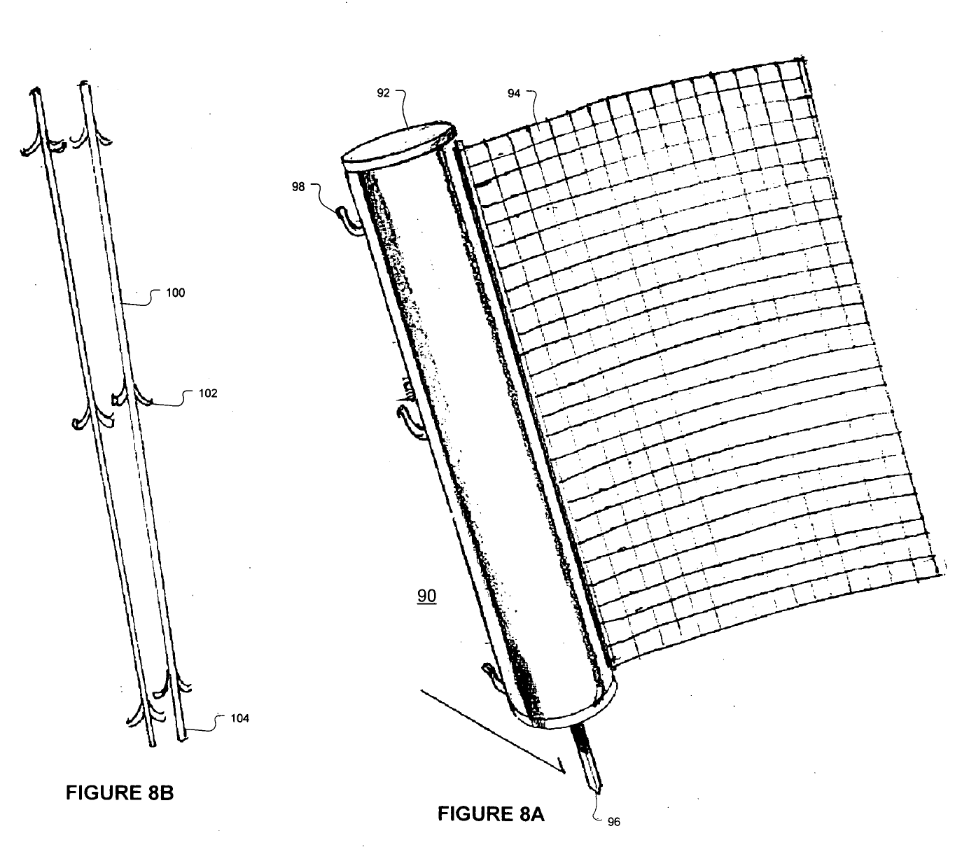

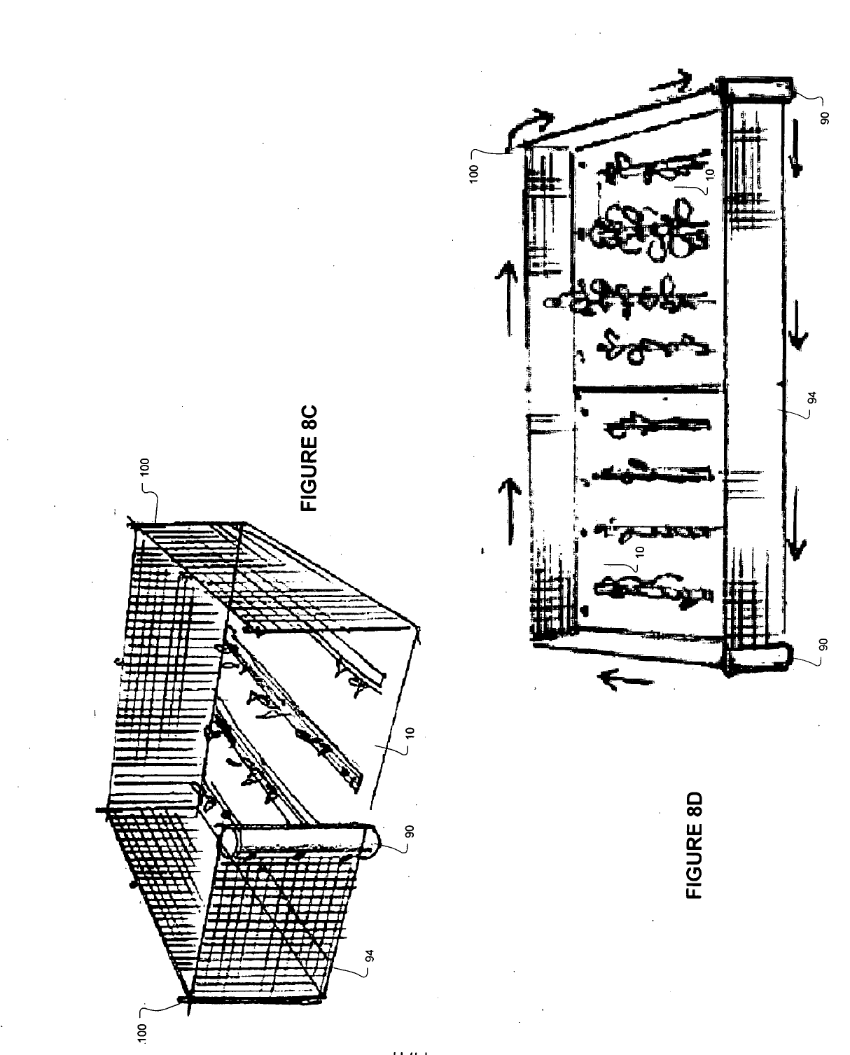

FIG. 8A is a simplified isometric diagram of a flightless animal exclusion system 90 that may be removably attached to one or more soil covers 10, 200 shown in FIGS. 1A and 1B in accordance with the present invention. The exclusion system 90 includes a retractable fence that may be coiled within a storage tube 92. The storage tube includes fence hooks 98 and stake 96. The stake 96 may placed in a grommet 22 of a soil cover 10, 200. In an embodiment the fence 94 may be uncoiled to a length sufficient to encompass the entire border of a soil cover architecture. In an embodiment where the soil architecture includes a single soil cover 10 (or two soil covers 200) that is six foot square, the fence may have a total length of about 24 feet when uncoiled completely. FIG. 8B is a simplified side view of a side pole or post 100 that may be employed in the exclusion system 90 in accordance with the present invention. The posts 100 include a stake 104 at the distal end and several fence hooks 102. In an embodiment the stakes 100 may be inserted in one or more grommets 22 of a soil cover 10, 200 and engaged to the fence 94 via the hooks 102 to hold the fence 94 securely to the cover 10, 200 (preventing or limiting tunneling to plants within the soil cover 10, 200.

FIG. 8C is a simplified isometric diagram of a flightless animal exclusion architecture including a single exclusion system 90 removably attached to the soil cover 10 in accordance with the present invention. In this embodiment the fence 94 is coupled to a post 100 at each soil cover 10 corner. The fencing storage tube 92 may be extended to the right corner to completely enclose the soil cover 10. FIG. 8D is a simplified isometric diagram of another flightless animal exclusion architecture including multiple exclusion systems 90 removably attached to the two, adjacent soil covers 10 in accordance with the present invention. In this embodiment the two, joined soil covers 10 are enclosed by two fencing systems 90. One fence 94 is completely extended from a fence tube 92 and coupled to hooks 98 of another fence tube 92. The second fence 94 is partially extended from the fence tube 92 and also coupled to the fence tube 92 hooks 98. In another embodiment, fence tubes 92 may accommodate different length and height fences 94. In an embodiment, the fence tubes 92 accommodate a 24 foot long by 3 foot high fence 94.

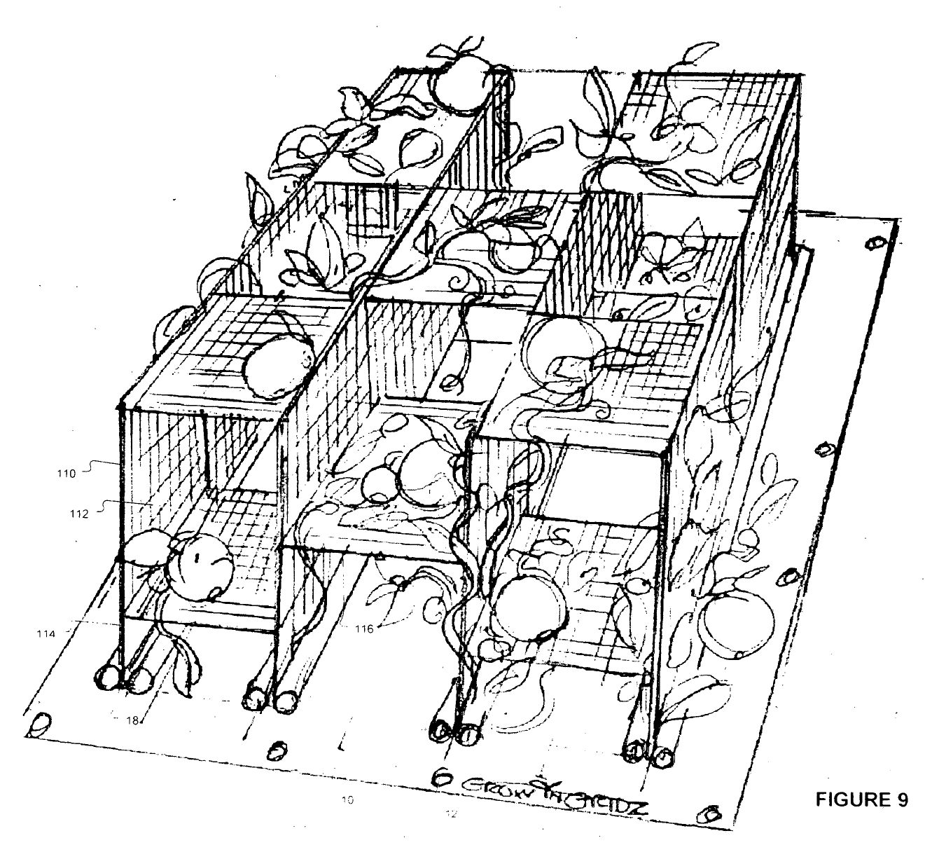

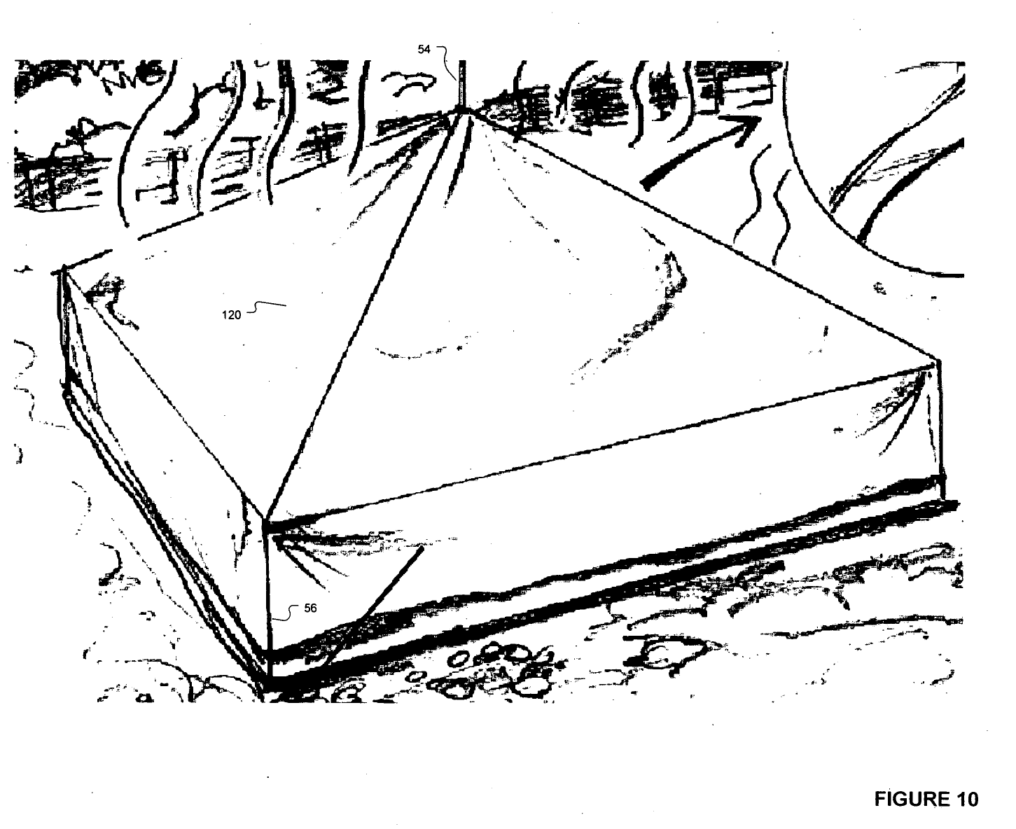

FIG. 9 is a simplified isometric diagram of a vertical extension system 110 that may be removably attached to a soil cover 10, 200 in accordance with the present invention. The vertical extension system 110 may include legs 114, cages 112, and cross members 116. In an embodiment the legs 114 may be inserted in the window rows 18, 218. The cages may be formed of an anodized wire or plastic. In an embodiment a user may place vine based plants in different cage sections to increase plant production. Different configurations of legs 114, cages 112, and cross members 116 may be employed to create different vertical plant extension systems.

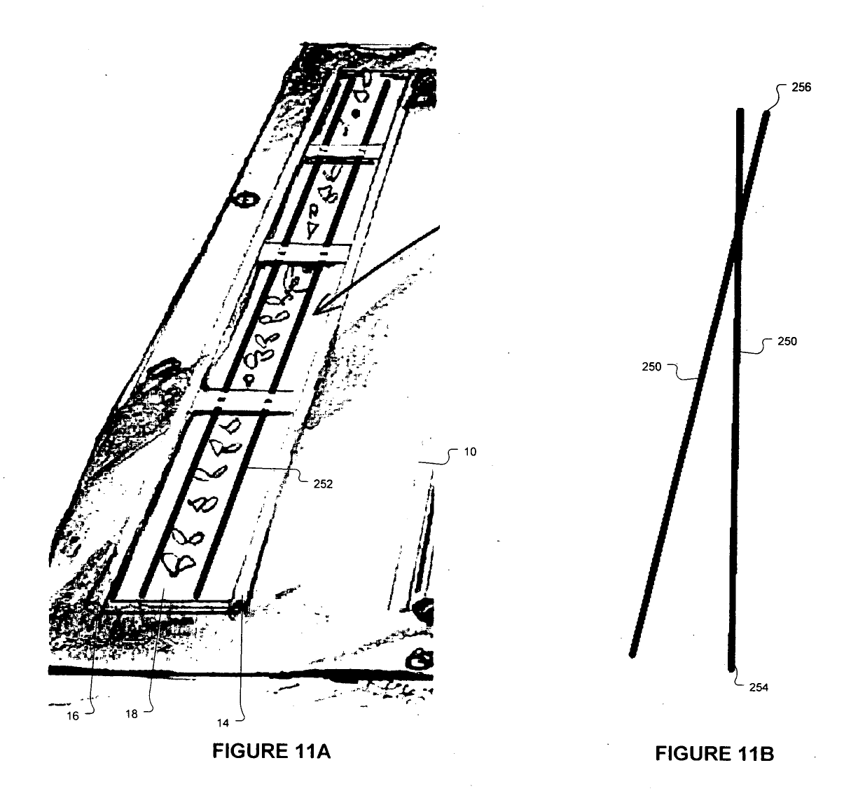

FIG. 11A is a simplified isometric diagram of a section of the soil cover 10, 200 shown in FIGS. 1A, 1B indicating fertilizer placement areas 252 in accordance with an embodiment of the present invention. In an embodiment, fertilizer may be placed in the window 18, 218 formed when the flaps 14, 214 and 16, 216 are rolled back. Then flaps 14, 214 and 16, 216 may be rolled toward each other to reduce the window 18, 218 size and cover placed fertilizer. In such an embodiment the flaps 14, 214 16, 216 may protect the fertilizer from ultraviolet light.

FIG. 11B is a simplified side view of fertilizer rods 250 that may be employed in the system shown in FIG. 11A in accordance with an embodiment of the present invention. In an embodiment the fertilizer to be placed in the windows 18, 218 may have a cylindrical configuration 250 with a distal end 254 and proximal end 256. The fertilizer rods 250 may contain nutrients that are slow released into the soil adjacent plants 32, 34 in the windows 18, 218. The window 18, 218 flaps 14, 214, 16, 216 may aid the release of the rod 250 nutrients by blocking at least a portion of ultraviolet light when the flaps are extended toward the plants 32, 34 and over rods 250 placed in the fertilizer areas 252 (thus reducing the window 18, 218 size).

While this invention has been described in terms of a best mode for achieving the objectives of the invention, it will be appreciated by those skilled in the art that variations may be accomplished in view of these teachings without deviating from the spirit or scope of the present invention. For example, each soil cover may include a single planting window, two planting windows, or other variations based on the soil cover surface area and plant spacing requirements.

What is claimed is:

1. A garden apparatus comprising:
a plant growing material cover comprised of a first breathable, water permeable, plant growing material coverable material and including a plurality of closable windows, each window having at least one reclosable flap comprised of a second breathable, water permeable material, the first and the second material capable of substantially preventing plant growth between itself and plant growing material.

2. The garden apparatus of claim 1, wherein the second material is substantially the same as the first material.

3. The garden apparatus of claim 1, wherein the first material is comprised of a polypropylene based non-woven material.

4. The garden apparatus of claim 1, wherein the plurality of closable windows are substantially similar in size.

5. The garden apparatus of claim 4, wherein the plurality of closable windows are substantially similar in orientation.

6. The garden apparatus of claim 1, wherein the plant growing material cover is substantially rectangular in shape.

7. The garden apparatus of claim 1, wherein the plant growing material cover is substantially rectangular in shape and the cover width is approximately an integer multiple of the cover length.

8. The garden apparatus of claim 1, each window of the plurality of windows further comprising an enlarged, tubular end, the enlarged tubular end including a sealable cavity capable of holding a pliable material.

9. The garden apparatus of claim 8, wherein the pliable material includes one of sand and water.

10. The garden apparatus of claim 1, wherein a window of the plurality of windows includes a locking mechanism that may releasably close at a section of the window.

11. The garden apparatus of claim 1, wherein a window of the plurality of windows includes at least two reclosable flaps comprised of the second breathable, water permeable material.

12. The garden apparatus of claim 11, wherein a window of the plurality of windows includes a locking mechanism that may releasably engage a first reclosable flap to a second reclosable flap.

13. The garden apparatus of claim 12, wherein the locking mechanism includes one of Velcro material and a zipper.

14. The garden apparatus of claim 1, wherein the plant growing material cover includes a plurality of grommets along its border.

15. The garden apparatus of claim 1, wherein the plant growing material cover includes a printed template indicating distance between a first and a second window of the plurality of windows.

16. A method comprising:
placing over a plant growing material a cover comprised of a first breathable, water permeable, plant growing material coverable material and including a plurality of closable windows, each window having at least one reclosable flap comprised of a second breathable, water permeable material, the first and the second material capable of substantially preventing plant growth between itself and plant growing material.

17. The method of claim 16, wherein the second material is substantially the same as the first material.

18. The method of claim 16, wherein the first material is comprised of a polypropylene based non-woven material.

19. The method of claim 16, wherein the plurality of closable windows are substantially similar in size.

20. The method of claim 19, wherein the plurality of closable windows are substantially similar in orientation.
